(19) United States
(12) Patent Application Publication
(10) Pub. No.: US 2008/0304398 A1
(43) Pub. Date: Dec. 11, 2008

(54) Optical Head That Improves Read Signal Characteristics

(76) Inventors: Kazutoshi Onozawa, Osaka (JP); Kazuhiko Yamanaka, Palo Alto, CA (US); Tomoaki Tojo, Osaka (JP); Takuya Okuda, Kyoto (JP); Shinichi Ijima, Osaka (JP); Junichi Kubo, Osaka (JP)

Correspondence Address: MCDERMOTT WILL & EMERY LLP, 600 13TH STREET, NW, WASHINGTON, DC, 20005-3096, US

(21) Appl. No.: 11/792,142

(22) PCT Filed: Dec. 1, 2005
(86) PCT No.: PCT/JP05/22508

§ 371 Date: Jan. 3, 2008

(30) Foreign Application Priority Data
Dec. 1, 2004 (JP) 2004-349145

(51) Int. Cl. G11B 7/135

(52) U.S. Cl. 369/112.29; 369/112.23; G9B/7.112

(57) ABSTRACT

In an optical head operable to record to and read from an optical recording medium, a beam emitted by a light-emitting element is reflected toward the light-emitting element by a first reflective mirror, and this reflected beam is reflected toward the optical recording medium by a second reflective mirror and focused on a recording surface of the optical recording medium. In this case, the first reflective mirror blocks a principal ray of the beam traveling toward the optical recording medium from the second reflective mirror, and the second reflective mirror consists of a plurality of concentric annular mirrors centered on the principal ray of the beam and separated from each other by a predetermined interval.

### CROSS-REFERENCE TO RELATED APPLICATION

This application is based on application no. 2004-349145 filed in Japan, the content of which is hereby incorporated by reference.

### TECHNICAL FIELD

The present invention relates to an optical head for recording to and reading from an optical recording medium such as CD, DVD or Blu-ray Disc, and more particularly to improving the signal characteristics when recorded information is read.

### BACKGROUND ART

Optical disc devices use an optical head to irradiate laser light onto an optical disc and read information using the reflected light. FIG. 1 is a cross-sectional view showing a typical structure of an optical head pertaining to the prior art. Optical head 13 is provided with a light-receiving element 1301, a light-emitting element 1302, a grating lens 1306 and reflective surfaces 1305 and 1308.

Laser light emitted by light-emitting element 1302 is focused onto the recording surface of an optical disc 1310 by grating lens 1306 after passing via reflective surfaces 1305 and 1308. Then, after passing via grating lens 1306 and reflective surface 1308, the reflected light is diffracted by a grating formed on reflective surface 1305 and directed to light-receiving element 1301. Broken lines 1307 in FIG. 1 indicate the diffracted light.

Light-receiving element 1301 outputs electrical signals according to the intensity of diffracted light 1307. The optical disc device uses the electrical signals to acquire information recorded on optical disc 1310, and controls the position of optical head 13. This structure enables optical head 13 to be reduced in size and weight. The structure of optical head 13 pertaining to the prior art is described, for example, in Japanese patents no. 2,738,204 and no. 2,790,264.

However, further improvements in recording density have been sought in recent years. In this respect, with the optical head pertaining to the prior art, a central portion of the laser light incident on optical disc 1310 is blocked by reflective surface 1305. This affects the light intensity distribution of the beam spot formed on the recording surface of optical disc 1310.

FIG. 2 is a graph showing the light intensity distribution of the beam spot. Light intensity distribution 14 of the beam spot has a main lobe 14a and side lobes 14b, as shown in FIG. 2. When the central portion of the laser light is blocked, as in the prior art, the peak value of side lobes 14b increases relative to the peak value of main lobe 14a due to the so-called super resolution phenomenon, making improvements in recording density difficult.

### DISCLOSURE OF THE INVENTION

In view of the above problem, an object of the present invention is to provide an optical head that reduces the side lobes of the beam spot.

To achieve this object, an optical head pertaining to the present invention is operable to read from and/or record to an optical recording medium, and includes a light-emitting element operable to emit a beam, a first reflective mirror adapted to reflect the beam toward the light-emitting element, and a second reflective mirror adapted to reflect the beam reflected by the first reflective mirror, toward the optical recording medium. In this case, the first reflective mirror blocks a principal ray of the beam traveling toward the optical recording medium from the second reflective mirror, the second reflective mirror consists of a plurality of concentric annular mirrors centered on the principal ray of the beam, and the concentric annular mirrors are separated from each other by a predetermined interval. This structure enables the side lobes of the beam spot to be reduced by blocking part of the beam emitted by the light-emitting element. Accordingly, high recording density can be realized.

A further optical head pertaining to the present invention is operable to read from and/or record to an optical recording medium, and includes a light-emitting element operable to emit a beam, a first reflective mirror adapted to reflect the beam toward the light-emitting element, a second reflective mirror adapted to reflect the beam reflected by the first reflective mirror, toward the optical recording medium, and a phase adjusting unit adapted to adjust a phase of the beam incident on the optical recording medium at a predetermined angle. In this case, the first reflective mirror blocks a principal ray of the beam traveling toward the optical recording medium from the second reflective mirror, and the phase adjusting unit is disposed on an optical path from the first reflective mirror to the optical recording medium. This structure enables the side lobes of the beam spot to be reduced by adjusting the phase of part of the beam emitted by the light-emitting element.

Furthermore, the phase adjusting unit may be one of a concave portion and a convex portion provided in the second reflective mirror. This structure enables the side lobes of the beam spot to be reduced by adjusting the phase of the beam reaching the recording surface of the optical disc through adjusting the optical path length of part of the beam emitted by the light-emitting element.

In this case, if a height D of the concave or convex portion is expressed by the equation

$$D = \frac{λ}{4 n}$$

where λ is a wavelength of the beam emitted by the light-emitting element, and n is a refractive index of a substance that the beam passes through when incident on the second reflective mirror, or if the refractive index n of the substance that the beam passes through when incident on the second reflective mirror is approximately equal to 1, and the height D of the concave or convex portion is expressed by the equation

$$D = \frac{λ}{4}$$

the side lobes of the beam spot can be reduced by inverting the phase of part of the beam emitted by the light-emitting element to offset the electric field intensity against the other components.

Furthermore, the optical head may further includes a lens surface disposed on an optical path from the light-emitting element to the optical recording medium and adapted to refract the beam, and the phase adjusting element may be one of a concave portion and a convex portion provided in the lens surface. This structure enables the side lobes of the beam spot to be reduced by adjusting the phase of part of the beam emitted by the light-emitting element. In this case, if a height D of the concave or convex portion is expressed by the equation

$$D = \frac{λ}{2 ( {n}_{1} - {n}_{0} )}$$

where λ is a wavelength of the beam emitted by the light-emitting element, n₀ is a refractive index of a substance that the beam passes through before being incident on the lens surface, and n₁ is a refractive index of a substance that the beam passes through after being incident on the lens surface, the side lobes of the beam spot can be reduced by inverting the phase of part of the beam emitted by the light-emitting element to offset the electric field intensity against the other components.

Furthermore, an optical head pertaining to the present invention is operable to read from and/or record to an optical recording medium, and includes a light-emitting element operable to emit a beam, a focusing element being a convex lens whose optical axis substantially coincides with a principal ray of the beam, and in which a central portion of a surface facing the light-emitting element is a transmission diffraction grating, and a central portion of a surface to face the optical recording medium is a first reflective mirror adapted to reflect the beam toward the light-emitting element, a second reflective mirror adapted to reflect the beam reflected by the first reflective mirror via the transmission diffraction grating, toward the focusing element, and a light-receiving element adapted to receive first-order diffracted light diffracted by the transmission diffraction grating, out of the reflected beam from the optical recording medium. In this case, the second reflective mirror consists of a plurality of concentric annular plane mirrors, the plane mirrors are separated from each other, and the reflective index between the plane mirrors is lower than the reflective index of the plane mirrors. This structure enables the side lobes of the beam spot to be reduced by blocking part of the beam emitted by the light-emitting element.

A further optical head pertaining to the present invention is operable to read from and/or record to an optical recording medium, and includes a light-emitting element operable to emit a beam, a focusing element being a convex lens whose optical axis substantially coincides with a principal ray of the beam, and in which a central portion of a surface facing the light-emitting element is a transmission diffraction grating, and a central portion of a surface to face the optical recording medium is a first reflective mirror adapted to reflect the beam toward the light-emitting element, a second reflective mirror adapted to reflect the beam reflected by the first reflective mirror via the transmission diffraction grating, toward the focusing element, and a light-receiving element adapted to receive first-order diffracted light diffracted by the transmission diffraction grating, out of the reflected beam from the optical recording medium. In this case, an annular portion of the second reflective mirror centered on the optical axis of the convex lens is one of elevated and depressed in an optical axis direction in comparison to other portions of the second reflective mirror.

Yet another optical head pertaining to the present invention is operable to read from and/or record to an optical recording medium, and includes a light-emitting element operable to emit a beam, a focusing element being a convex lens whose optical axis substantially coincides with a principal ray of the beam, and in which a central portion of a surface facing the light-emitting element is a transmission diffraction grating, and a central portion of a surface to face the optical recording medium is a first reflective mirror adapted to reflect the beam toward the light-emitting element, a second reflective mirror adapted to reflect the beam reflected by the first reflective mirror via the transmission diffraction grating, toward the focusing element, and a light-receiving element adapted to receive first-order diffracted light diffracted by the transmission diffraction grating, out of the reflected beam from the optical recording medium. In this case, an annular portion of a lens surface of the focusing element centered on the optical axis of the convex lens is expressed by a different lens function to other portions of the lens surface.

A still further optical head pertaining to the present invention is operable to read from and/or record to an optical recording medium, and includes a light-emitting element operable to emit a beam, a focusing element being a convex lens whose optical axis substantially coincides with a principal ray of the beam, and in which a central portion of a surface facing the light-emitting element is a transmission diffraction grating, a portion of the surface facing the light-emitting element excluding the transmission diffraction grating is a concave mirror, and a central portion of a surface to face the optical recording medium is a first reflective mirror adapted to reflect the beam toward the light-emitting element, and a light-receiving element adapted to receive first-order diffracted light diffracted by the transmission diffraction grating, out of the reflected beam from the optical recording medium. In this case, an annular portion of the concave mirror centered on the optical axis of the convex lens is one of elevated and depressed in comparison to other portions of the concave mirror. This structure enables the side lobes of the beam spot to be reduced by adjusting the phase of part of the beam emitted by the light-emitting element.

### BRIEF DESCRIPTION OF THE DRAWINGS

FIG. 1 is a cross-sectional view showing a typical structure of an optical head pertaining to the prior art;

FIG. 2 is a graph showing the light intensity distribution of a beam spot formed on the recording surface of an optical disc by an optical head pertaining to the prior art;

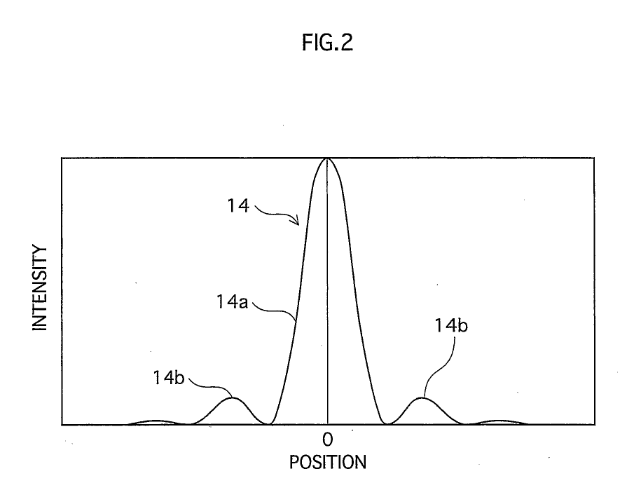

FIG. 3 is a cross-sectional view showing a structure of an optical head pertaining to an embodiment 1 of the present invention;

FIG. 4 shows a cross-sectional view and a plan view of a support plate 106 constituting an optical head 1 pertaining to embodiment 1 of the present invention as seen from a focusing element side;

FIG. 5 is a cross-sectional view showing the optical path of laser light emitted by a light-emitting element 110 until the laser light is incident on a light-receiving element 111 constituting optical head 1 pertaining to embodiment 1 of the present invention;

FIGS. 6A-6B are graphs showing respectively the light intensity distribution and the electric field intensity distribution of a beam spot formed on the recording surface of an optical disc by optical head 1 pertaining to embodiment 1 of the present invention;

FIGS. 7A-7B illustrate the shape of a support plate and a mirror surface pertaining to an embodiment 2 of the present invention, FIG. 7A being a plan view and FIG. 7B being a cross-sectional view.

FIGS. 8A-8B are graphs showing respectively the light intensity distribution and the electric field intensity distribution of a beam spot formed on the recording surface of an optical disc by an optical head pertaining to embodiment 2 of the present invention;

FIG. 9 is a cross-sectional view showing a structure of an optical head pertaining to an embodiment 3 of the present invention;

FIG. 10 is a cross-sectional view of a focusing element 701 constituting the optical head pertaining to embodiment 3 of the present invention;

FIG. 11 is a cross-sectional view showing the optical path of laser light emitted by a light-emitting element 710 until the laser light is incident on a light-receiving element 711 constituting an optical head 7 pertaining to embodiment 3 of the present invention;

FIG. 12 is a cross-sectional view showing the shape of a focusing element pertaining to a variation 1 of embodiment 3 of the present invention;

FIG. 13 is a cross-sectional view showing the structure of an optical head pertaining to an embodiment 4 of the present invention; and

FIG. 14 is a cross-sectional view showing the optical characteristics of the optical head pertaining to embodiment 4 of the present invention.

### BEST MODE FOR CARRYING OUT THE INVENTION

Embodiments of an optical head pertaining to the present invention are described below with reference to the drawings.

### 1. Embodiment 1

Firstly, a feature of an optical head pertaining to an embodiment 1 of the present invention lies in the structure of reflective surfaces that guide the laser light to the optical disc.

### 1-1. Structure of Optical Head

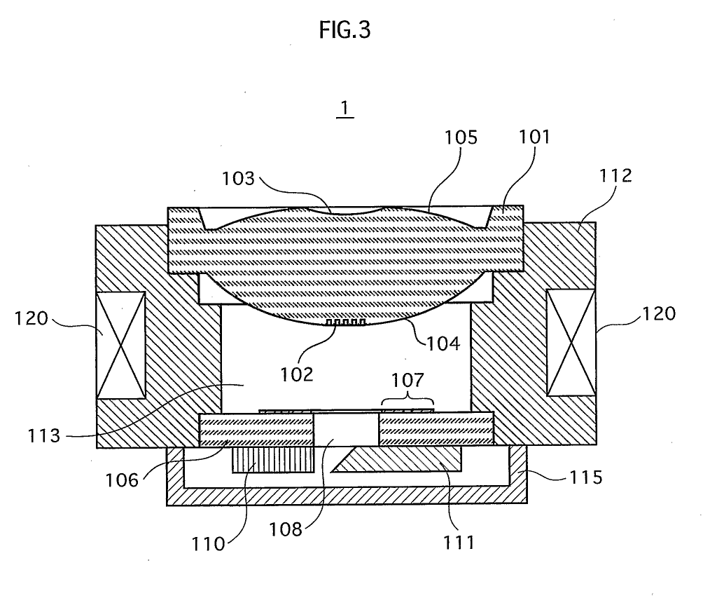

Firstly, the structure of an optical head pertaining to the present embodiment is described. FIG. 3 is a cross-sectional view showing the structure of the optical head pertaining to the present embodiment. Optical head 1 is provided with a housing 112, a magnet 120, a cap 115, a support plate 106, a light-emitting element 110, a focusing element 101 and a light-receiving element 111.

A thru hole 113, circular in plan view, is provided in a central portion of housing 112. Focusing element 101 is fitted into the opening at one end of the housing, and support plate 106 is fitted into the opening at the other end of the housing. Magnet 120 is set into a groove around the outside of housing 112, and used together with an electromagnet (not depicted) to control the position of the optical head.

Focusing element 101 is a generally convex lens shaped member, the outer edge of which is joined to housing 112. A central portion of focusing element 101 on the support plate side is a transmission diffraction grating 102 (hereinafter, simply “diffraction grating”).

Surrounding diffraction grating 102 is a lens surface 104. A central portion of focusing element 101 on the optical disc side is a mirror surface 103 that reflects light incident from the support plate side. Mirror surface 103 is a convex mirror, and surrounding mirror surface 103 is a lens surface 105.

Support plate 106 is an annular member, and formed on the main surface thereof on the focusing element side is a mirror surface 107. Mirror surface 107 an annular plane mirror. Light-emitting element 110 and light-receiving element 111 are fixed to the main surface of support plate 106 facing away from focusing element 101 using a resin, and covered with cap 115.

Cap 115 is composed of a material with light-blocking ability, and prevents extraneous light entering light-receiving element 111. Light-emitting element 110 is a semiconductor laser element, and light-receiving element 111 is a multi-photodetector. The end surface of light-receiving element 111 on the light-emitting element side is a plane mirror.

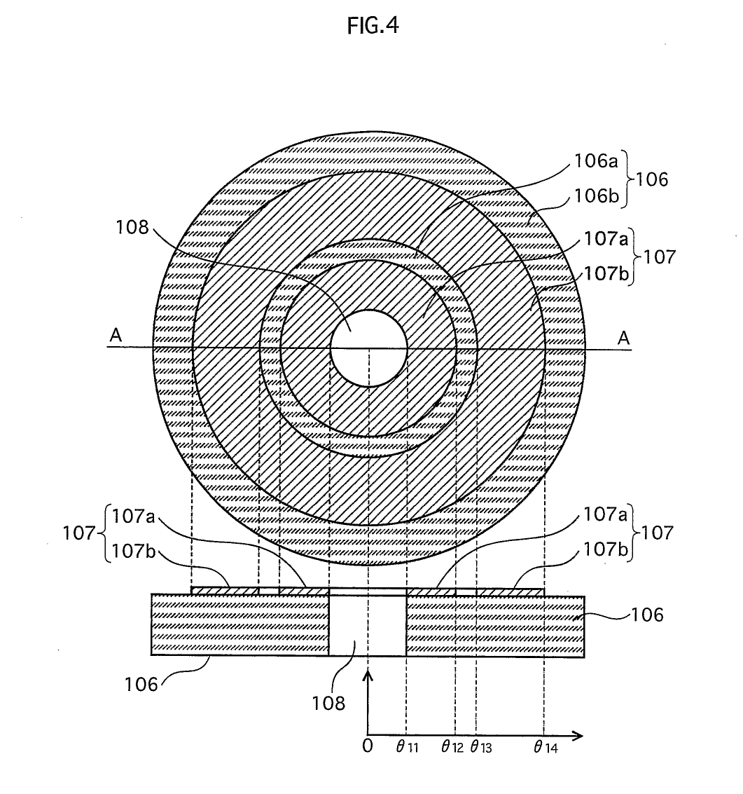

FIG. 4 shows a cross-sectional view and a plan view of support plate 106 as seen from the focusing element side. The cross-sectional view of support plate 106 shown in FIG. 4 is a cross-section occurring at the A-A line shown in the FIG. 4 plan view. Support plate 106 is a flat annular member with a thru hole 108 in the center thereof, as shown in FIG. 4. A mirror surface 107 is formed on one of the main surfaces of support plate 106.

Mirror surface 107 is composed of annular mirror surfaces 107a and 107b, and these mirror surfaces 107a and 107b are disposed concentrically with support plate 106. Note that support plate 106 is a non-reflective member, and that portions 106a and 106b of support plate 106 not covered by mirror surface 107 do not reflect the laser light.

The inside diameter of mirror surface 107a corresponds in size to an angle of incidence θ₁₁ on optical disc 180 of the reflected light of mirror surface 107a when refracted by lens surfaces 104 and 105, and the outside diameter of mirror surface 107a corresponds in size to an angle of incidence θ₁₂ on the optical disc. The inside and outside diameters of mirror surface 107b respectively correspond in size to angles of incidence θ₁₃ and θ₁₄ on the optical disc of the reflected light of mirror surface 107b.

### 1-2. Optical Characteristics of Optical Head 1

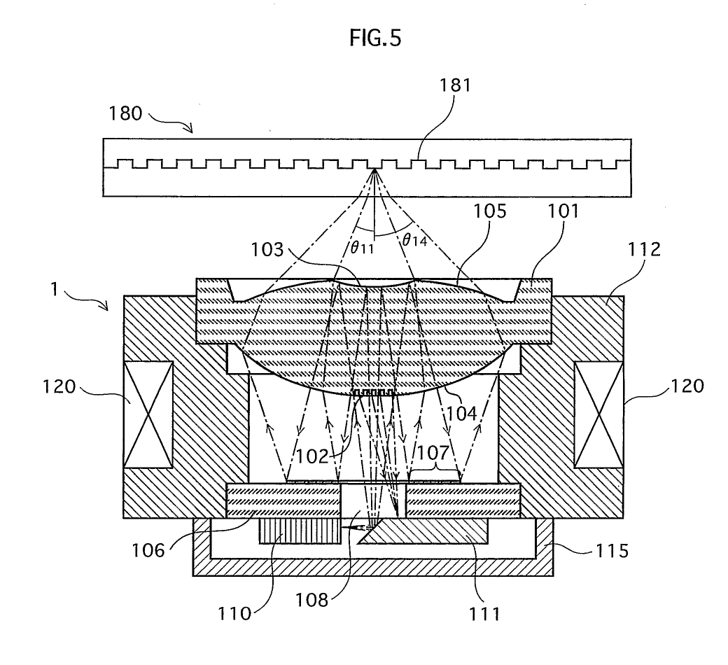

The optical characteristics of optical head 1 are described next. FIG. 5 is a cross-sectional view showing the optical path of laser light emitted by light-emitting element 110 until the laser light is incident on a light-receiving element 111. After being reflected by the mirror surface formed on the end surface of light-receiving element 111 on the light-emitting element side, laser light emitted by light-emitting element 110 passes through thru hole 108 and diffraction grating 102, is reflected by mirror surface 103, and then passes through lens surface 104 on its way to mirror surface 107, as shown in FIG. 5.

Only laser light whose angle of incidence on optical disc 180 will be from θ₁₁ to θ₁₂ and from θ₁₃ to θ₁₄ is reflected back toward focusing element 101 by mirror surface 107. The reflected laser light is then successively refracted by lens surfaces 104 and 105, and focused onto the recording surface of optical disc 180. The electric field intensity distribution of the beam spot formed on the recording surface of optical disc 180 is expressed by the equation

$$U ( r ) = {[ \begin{matrix}\frac{{sin}^{2} θ}{{K}_{1}} \cdot \\ \frac{{J}_{1} ( sin θ \cdot r \cdot 2 π / λ )}{sin θ \cdot r \cdot 2 π / λ}\end{matrix} ]}_{θ = {θ}_{13}}^{θ = {θ}_{14}} + {[ \begin{matrix}\frac{{sin}^{2} θ}{{K}_{1}} \cdot \\ \frac{{J}_{1} ( sin θ \cdot r \cdot 2 π / λ )}{sin θ \cdot r \cdot 2 π / λ}\end{matrix} ]}_{θ = {θ}_{11}}^{θ = {θ}_{12}}$$

Here, θ₁₁ to θ₁₄ are the angles of incidence of the aforementioned laser light on the optical disc, r is the distance on recording surface 181 from the optical axis of focusing element 101, and K₁ is a constant corresponding to light intensity. J₁(x) is the first-order Bessel function of the first kind.

The first term on the right side of the equation expresses the electric field intensity distribution resulting from the laser light reflected by mirror surface 107b, and the second term expresses the electric field intensity distribution resulting from the laser light reflected by mirror surface 107a. The light intensity distribution of the beam spot is expressed by the equation

I(r)=|U(r)|²

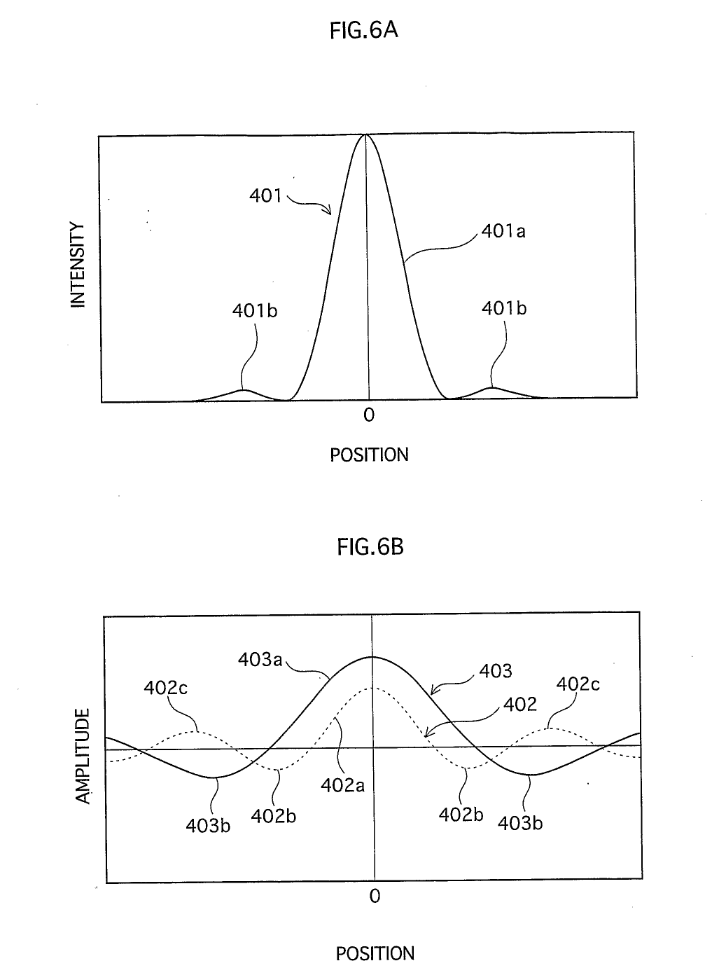

FIGS. 6A and 6B are graphs showing respectively the light intensity distribution and the electric field intensity distribution of a beam spot formed on recording surface 181 of optical disc 180. In FIG. 6A, a graph 401 expresses the light intensity distribution of the spot beam produced by all components of the laser light. In FIG. 6B, a graph 402 expresses the electric field intensity distribution on recording surface 181 for laser light reflected by mirror surface 107a, and a graph 403 expresses the electric field intensity distribution on recording surface 181 for laser light reflected by mirror surface 107b.

The position of the side lobes is different for graphs 402 and 403, with the side lobes canceling each other out, as shown in FIG. 6B. Furthermore, since the main lobes rise up together, a desirable light intensity distribution such as shown by graph 401 can be obtained.

Thus, by adjusting the shape of mirror surface 107a and mirror surface 107b, the side lobes of the beam spot can be reduced and high recording density realized.

For example, if the wavelength of laser light emitted by the light-emitting element is 660 nm, and the angles of incidence θ₁₁ to θ₁₄ on optical disc 180 are respectively 13.3°, 24.1°, 30.7° and 35.3°, the peak light intensity of the side lobes can be reduced to 4.2% of the peak light intensity of the main lobe.

On the other hand, with an optical head pertaining to the prior art, the electric field intensity of the beam spot is expressed by the equation

$$U ( r ) = {[ \frac{{sin}^{2} θ}{{K}_{2}} \cdot \frac{{J}_{1} ( sin θ \cdot r \cdot 2 π / λ )}{sin θ \cdot r \cdot 2 π / λ} ]}_{θ = {θ}_{1}}^{θ = {θ}_{2}}$$

Here, θ₁ to ←₂ are the angles of incidence of the laser light, r is the distance on the recording surface from the optical axis of grating lens 1306, and K₂ is a constant corresponding to light intensity. Light up to an angle of incidence θ₁ from the optical axis of grating lens 1306 is blocked by reflective surface 1305, and does not contribute to the light intensity distribution of the beam spot.

In the case where the waveform λ of the laser light is 660 nm, and the angles of incidence θ₁ and θ₂ on the optical disc are respectively 13.3° and 35.3°, the peak value of the side lobes will be as much as 7.0% of the peak value of the main lobe.

Given that the light intensity of the laser light reflected by recording surface 181 of optical disc 180 depends on the recorded state of the recording surface, recorded information to be read is only reflected in the light intensity of the main lobe. On the other hand, since recorded information to be read is not reflected in the light intensity of the side lobes, the light intensity of the side lobes ultimately has an adverse effect on the intensity of the laser light incident on the light-receiving element.

This adverse effect increases as the light intensity of the side lobes increases. The effect of the side lobes cannot be eliminated through processing the electrical signals obtained as a result of photoelectric conversion performed by the light-receiving element.

In contrast, since the side lobes are reduced according to the present invention as noted above, the light intensity of reflected light accurately expresses the recorded state of the recording surface. The reflected light from recording surface 181 is refracted successively by lens surfaces 105 and 104, reflected by mirror surface 107, refracted by lens surface 104, and reflected by mirror surface 103, before being diffracted by diffraction grating 102.

First-order diffracted light of the reflected light diffracted by diffraction grating 102 is incident on light-receiving element 111. Light-receiving element 111 photoelectrically converts the incident light to obtain electrical signals that depend on the light intensity of the incident light, and outputs the electrical signals. In this way, optical head 1 reads information recorded on optical disk 180.

Note that as variations of the present embodiment, only one of lens surfaces 104 and 105 may be provided, or a Fresnel lens with a diffraction effect may be used. Mirror surface 107 may also be divided into three or more mirror surfaces.

### 2. Embodiment 2

An embodiment 2 of the present invention is described next. While having generally the same structure as the optical head pertaining to embodiment 1, an optical head pertaining to the present embodiment differs in the shape of the support plate and the mirror surfaces. The following description focuses solely on these differences.

### 2-1. Shape of Support Plate and Mirror Surfaces

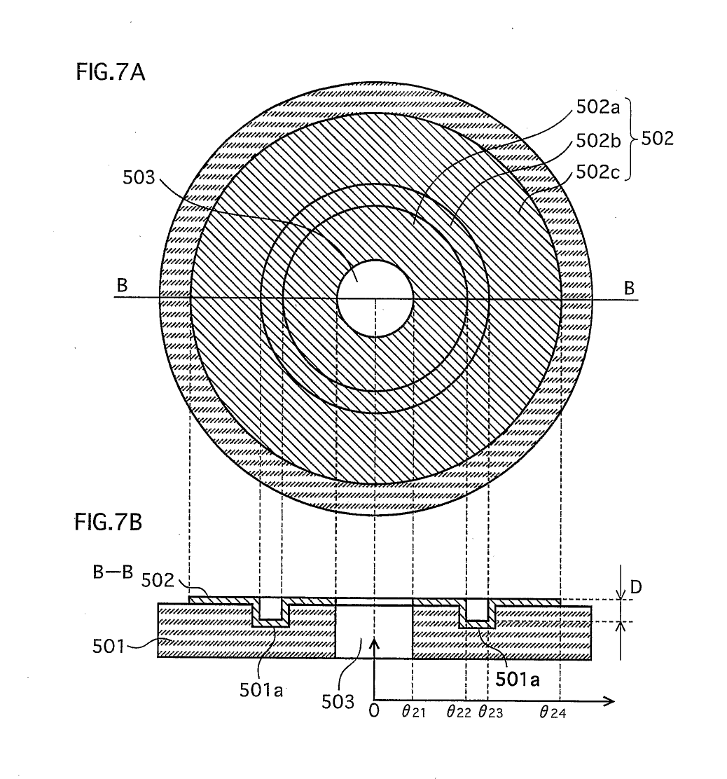

The optical head pertaining to the present embodiment has a support plate and mirror surfaces, similarly to the optical head pertaining to embodiment 1. FIGS. 7A and 7B show the support plate and mirror surfaces pertaining to the present embodiment. FIG. 7A is a plan view, and FIG. 7B is a cross-sectional view. An annular groove 501a is provided in the surface of a support plate 501 pertaining to the present embodiment that faces the focusing element (not depicted), as shown in FIGS. 7A and 7B. A height D of groove 501a is equal to a ¼ wavelength of laser light emitted by the light-emitting element. Note that in the present embodiment, laser light incident on a mirror surface 502 passes through the air. A thru hole 503 is provided in a central portion of support plate 501 in plan view, similarly to support plate 106 of embodiment 1.

Mirror surface 502 is provided on the focusing element side of support plate 501, similarly to mirror surface 107 of embodiment 1. Whereas mirror surface 107 is divided into a plurality of mirror surfaces, mirror surface 502 is formed as one piece. Mirror surface 502, which is an annular body that encloses thru hole 503 and is concentric with support plate 501, covers the inner wall of groove 501a. Mirror surface 502, including the portion in groove 501a, is substantially uniform in thickness.

Support plate 501 may be composed of silicon, and groove 501a may be formed through wafer etching. Mirror surface 502 is obtained by forming a dielectric multilayer film on support plate 501. Thru hole 503 can be formed using a drill or the like.

Mirror surface 502 is divided into three continuous mirror surfaces 502a, 502b, and 502c, as shown in FIG. 7A. Mirror surfaces 502a and 502c are equivalent to mirror surfaces 107a and 107b of embodiment 1. Mirror surface 502b is provided over the inner wall of groove 501a. Laser light whose angle of incidence on optical disc 180 will be from θ₂₁ to θ₂₂ is incident on mirror surface 502a. Furthermore, laser light whose angle of incidence on optical disc 180 will be from θ₂₂ to θ₂₂ is incident on mirror surface 502b, and laser light whose angle of incidence on optical disc 180 will be from θ₂₃ to θ₂₄ is incident on mirror surface 502c.

The portion of mirror surface 502b facing the focusing element differs in position in an optical axis direction from mirror surfaces 502a and 502c by height D of groove 501a. This results in the optical path length of laser light reflected by mirror surface 502b being longer than the optical path length of laser light reflected by mirror surfaces 502a and 502c by 2D, or a ½ wavelength.

### 2-2. Optical Characteristics

The optical characteristics of the optical head pertaining to the present embodiment are described next. When laser light is reflected by mirror surface 502, laser light incident on mirror surface 502 that is reflected by mirror surface 502b differs in optical path length from laser light reflected by mirror surfaces 502a and 502c by a ½ wavelength, and is thus out of phase 180 degrees. The electric field intensity distribution of the beam spot formed by this laser light on the recording surface of the optical disc is expressed by the equation

$$U ( r ) = {[ \begin{matrix}\frac{{sin}^{2} θ}{{K}_{3}} \cdot \\ \frac{{J}_{1} ( sin θ \cdot r \cdot 2 π / λ )}{sin θ \cdot r \cdot 2 π / λ}\end{matrix} ]}_{θ = {θ}_{23}}^{θ = {θ}_{24}} - {[ \begin{matrix}\frac{{sin}^{2} θ}{{K}_{3}} \cdot \\ \frac{{J}_{1} ( sin θ \cdot r \cdot 2 π / λ )}{sin θ \cdot r \cdot 2 π / λ}\end{matrix} ]}_{θ = {θ}_{22}}^{θ = {θ}_{23}} + {[ \begin{matrix}\frac{{sin}^{2} θ}{{K}_{3}} \cdot \\ \frac{{J}_{1} ( sin θ \cdot r \cdot 2 π / λ )}{sin θ \cdot r \cdot 2 π / λ}\end{matrix} ]}_{θ = {θ}_{21}}^{θ = {θ}_{22}}$$

Here, θ₂₁ to θ₂₄ are angles of incidence on the optical disc, and K₃ is a constant corresponding to light intensity. The first term on the right hand side expresses the electric field intensity distribution resulting from laser light reflected by mirror surface 502c, and the second and third terms express the electric field intensity distributions resulting from laser light reflected by mirror surfaces 502b and 502a, respectively.

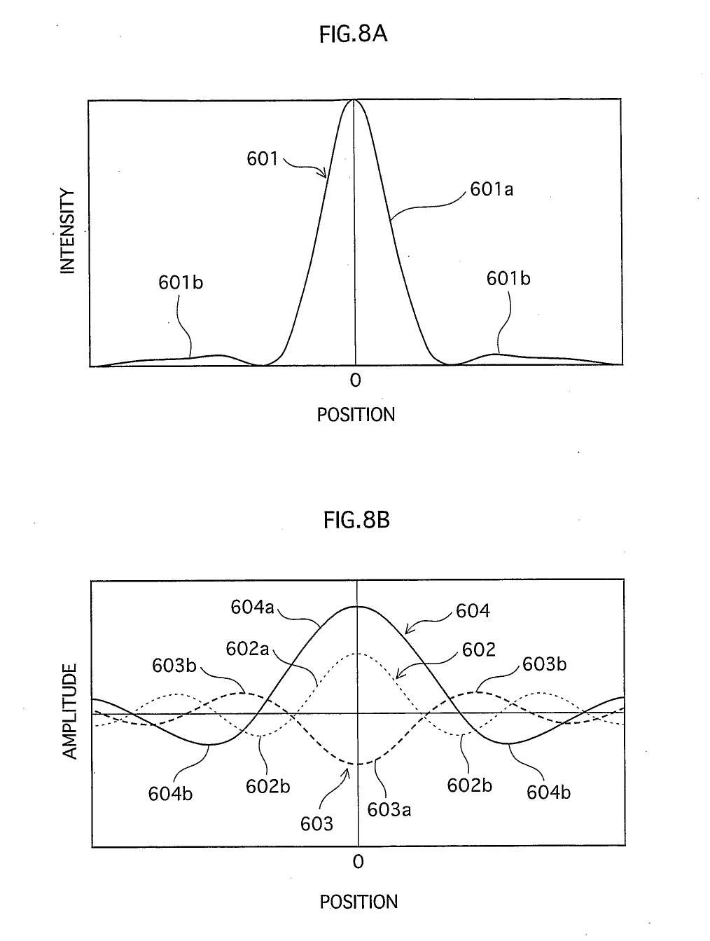

FIGS. 8A and 8B are graphs showing respectively the light intensity distribution and the electric field intensity distribution of the beam spot formed on the recording surface of the optical disc by the optical head pertaining to the present embodiment. A graph 601 in FIG. 8A expresses the light intensity distribution of the beam spot produced by all components of the laser light. Graphs 602 to 604 in FIG. 8B express the electric field intensity distributions for laser light reflected by mirror surfaces 502a to 502c, respectively.

The first-order minimal value 602b of electric field intensity 602, the first-order maximal value 603b of electric field intensity 603, and the first-order minimal value 604b of electric field intensity 604 cancel each other out, as shown in FIG. 8B. This results in the side lobes of the beam spot being reduced, as shown in FIG. 8A. Furthermore, since the main lobes 602a and 604a of electric field intensities 602 and 604 rises up together, the main lobe 603a of electric field intensity 603 has almost no effect.

For example, if the wavelength of laser light emitted by the light-emitting element is 660 nm, and the angles of incidence θ₂₁ to θ₂₄ on the optical disc are respectively 13.3°, 26.0°, 30.5° and 35.3°, the peak light intensity of the side lobes can be reduced to 3.4% of the peak light intensity of the main lobe.

### 2-3. Variations of Embodiment 2

The present embodiment is described above in terms of a groove being provided in support plate 501 as a mirror surface 502b. Needless to say, the present invention is not limited to this, and may alternatively be constituted as follows. That is, a flat convex portion may be provided as a mirror surface in a position corresponding to the groove. Since the light reflected by the mirror surface is shortened by a ½ wavelength if the height of the convex part is made the same as the depth of the groove, a corresponding phase shift is produced and an effect similar to the above is obtained.

Furthermore, the present embodiment is described above in terms of the height D of the groove being set to a ¼ wavelength. Needless to say, the present invention is not limited to this. For example, if the height D of the groove is set to 1/(4n) in the case where the groove is filled with a substance having a refractive index n, the optical path difference of reflected light can be set to a ½ wavelength.

### 3. Embodiment 3

An embodiment 3 of the present invention is described next. While having generally the same structure as the optical head pertaining to embodiment 1, an optical head pertaining to the present embodiment differs in having a groove in the surface of the focusing element instead of a plurality of mirror surfaces on the support plate. The following description focuses solely on this difference.

### 3-1. Structure of Optical Head

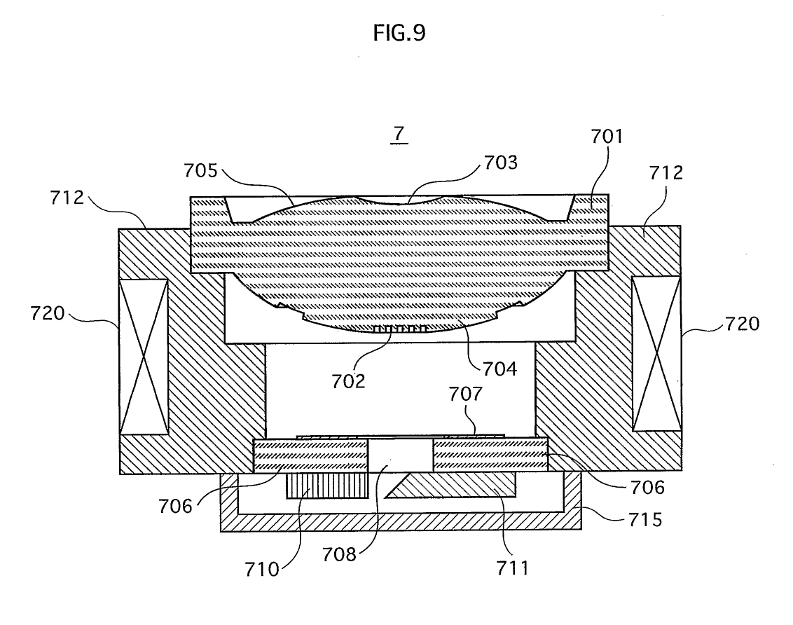

FIG. 9 is a cross-sectional view showing the structure of the optical head pertaining to the present embodiment. Optical head 7 is provided with a housing 712, a magnet 720, a cap 715, a support plate 706, a light-emitting element 710, a focusing element 701, and a light-receiving element 711, as shown in FIG. 9. A mirror surface 707 is disposed on the focusing element side of support plate 706. Mirror surface 707 is an annular plane mirror formed as one piece.

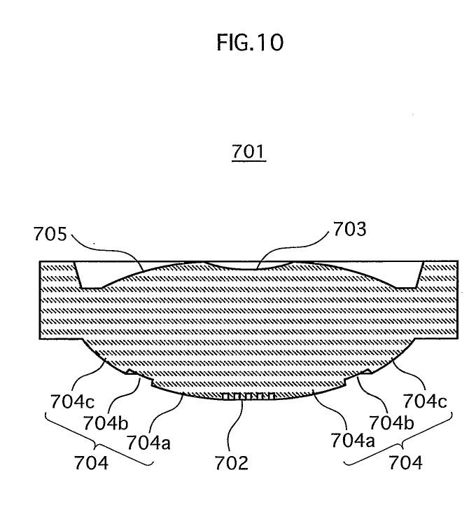

FIG. 10 is a cross-sectional view of a focusing element 701 pertaining to the present embodiment. Focusing element 701 is a generally convex lens shaped member, the outer edge of which is joined to housing 712. A central portion of the surface of focusing element 701 facing support plate 706 is a diffraction grating 702. Surrounding diffraction grating 702 is a lens surface 704. A central portion of the surface of focusing element 701 to face the optical disc is a mirror surface 703. Mirror surface 703 is a convex mirror that reflects light incident from the support plate side. Surrounding mirror surface 703 is a lens surface 705.

Lens surface 704 is divided into lens surfaces 704a, 704b, and 704c. Lens surfaces 704a and 704c are aspheric surfaces expressed by a single aspheric function. Lens surface 704b is an annular groove that is centered on the optical axis of focusing element 701 and divides lens surfaces 704a and 704c. The base of lens surface 704b is an aspheric surface expressed by a different aspheric function to the aspheric function that expresses lens surfaces 704a and 704c.

The boundary lines between the lens surfaces are aligned with appropriate angles of incidence of the laser light. A height D of lens surface 704b is expressed by the following equation, using a wavelength λ of laser light emitted by light-emitting element 710, a refractive index n₁ of the material constituting focusing lens 701, and a refractive index n₀ of air:

$$D = \frac{λ}{2 ( {n}_{1} - {n}_{0} )}$$

Since this results in light that passes through lens surface 704b being out of phase with light that passes through lens surfaces 704a and 704c by a ½ wavelength, the side lobes can be reduced as described in embodiment 2.

### 3-2. Optical Characteristics

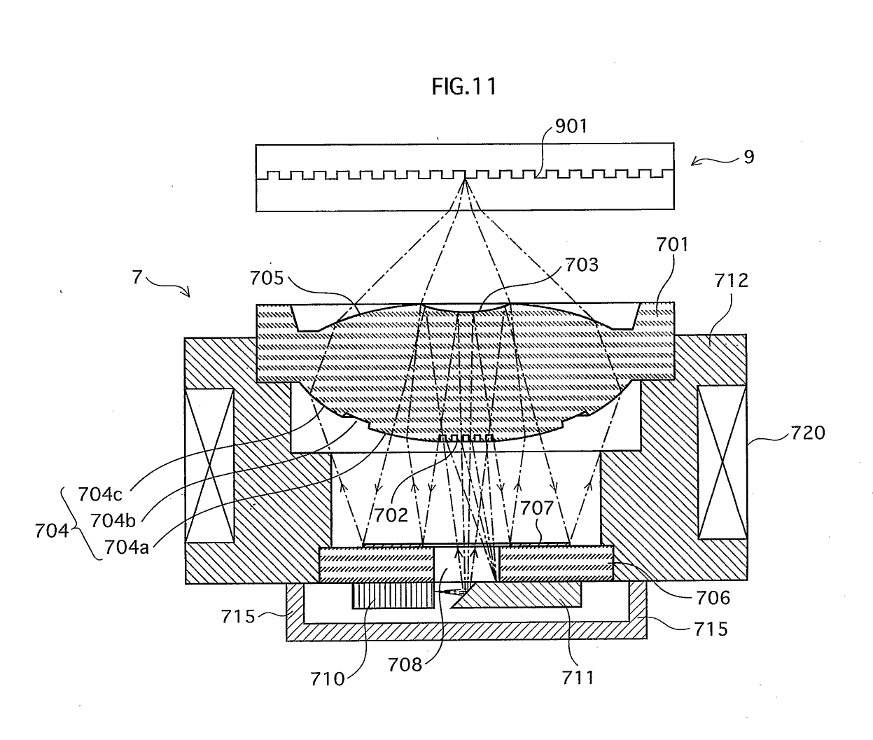

The optical characteristics of optical head 7 are described next. FIG. 11 is a cross-sectional view showing the optical path of laser light emitted by light-emitting element 710 until the laser light is incident on light-receiving element 711. After being reflected through diffraction grating 702 by the mirror surface provided on the end surface of light-receiving element 711, laser light emitted by light-emitting element 710 is reflected by mirror surface 703 onto mirror surface 707 via lens surface 704, and the reflected light of mirror surface 707 is then focused onto a recording surface 901 of an optical disc 9 after being refracted successively by lens surfaces 704 and 705, as shown in FIG. 11.

Since laser light that passes through lens surface 704b is out of phase 180 degrees with laser light that passes through lens surfaces 704a and 704c in this case, as noted above, the side lobes of the beam spot formed on recording surface 901 are reduced. Reflected light having a light intensity that accurately reflects the recorded state of recording surface 901 can be obtained as a result. Light reflected by recording surface 901 is refracted onto mirror surface 707 by lens surfaces 705 and 704, and the reflected light of mirror surface 707 is then diffracted by diffraction grating 702 after being reflected by mirror surface 703 via lens surface 704. Information recorded on optical disc 9 is read as a result of first-order diffracted light being incident on light-receiving element 711.

### 3-3. Variations of Present Embodiment

Variations of the present embodiment are described below.

(1) The present embodiment is described above in terms of the side lobes being reduced by providing an annular groove in lens surface 704 as a lens surface 704b. Needless to say, the present invention is not limited to this, and may alternatively be constituted as follows.

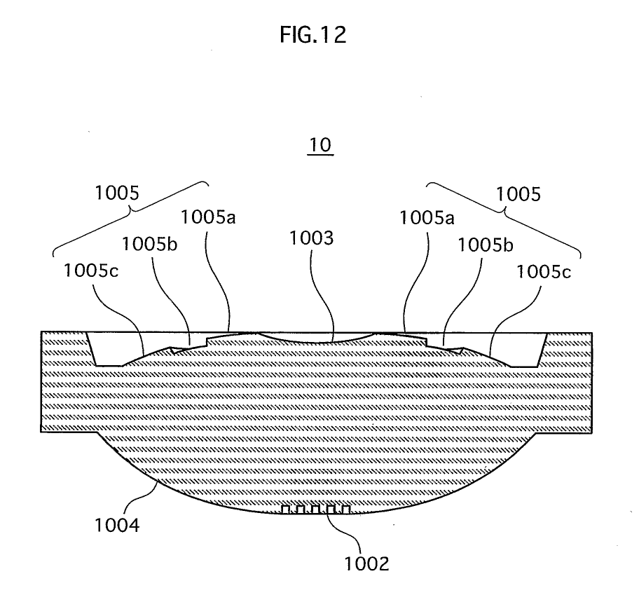

FIG. 12 is a cross-sectional view showing the shape of a focusing element pertaining to the present variation. While having generally the same shape as focusing element 701, focusing element 10 has a groove in the lens surface to face the optical disc, in contrast to focusing element 701, which has a groove in lens surface 704 facing support plate 706.

A lens surface 1005 is composed of lens surfaces 1005a, 1005b, and 1005c. Lens surfaces 1005a and 1005c are aspheric surfaces expressed by a single aspheric function. Lens surface 1005b is an annular groove centered on the optical axis of focusing element 10. The base of lens surface 1005b is an aspheric surface. The height D of the groove is again expressed by the equation

$$D = \frac{λ}{2 ( {n}_{1} - {n}_{0} )}$$

Note that, similarly to the above, λ is the wavelength of laser light emitted by light-emitting element 710, n₁ is the refractive index of the material that constitutes focusing element 10, and n₀ is the refractive index of air. The side lobes can also be reduced with this structure by aligning the boundary lines between the lens surfaces with appropriate angles of incidence of the laser light.

(2) The present embodiment is described above in terms of an annular groove being provided in lens surface 704 as a lens surface 704b. Needless to say, the present invention is not limited to this, and may alternatively be constituted as follows. That is, a flat annular convex portion may be provided as a lens surface on lens surface 704. Effects similar to those noted above can be obtained even with this structure.

### 4. Embodiment 4

An embodiment 4 of the present invention is described next. While having generally the same structure as the optical head pertaining to embodiment 1, an optical head pertaining to the present embodiment differs in that the surface of the focusing element facing the light-emitting element is a reflective surface. The following description focuses solely on this difference.

### 4-1. Structure of Optical Head

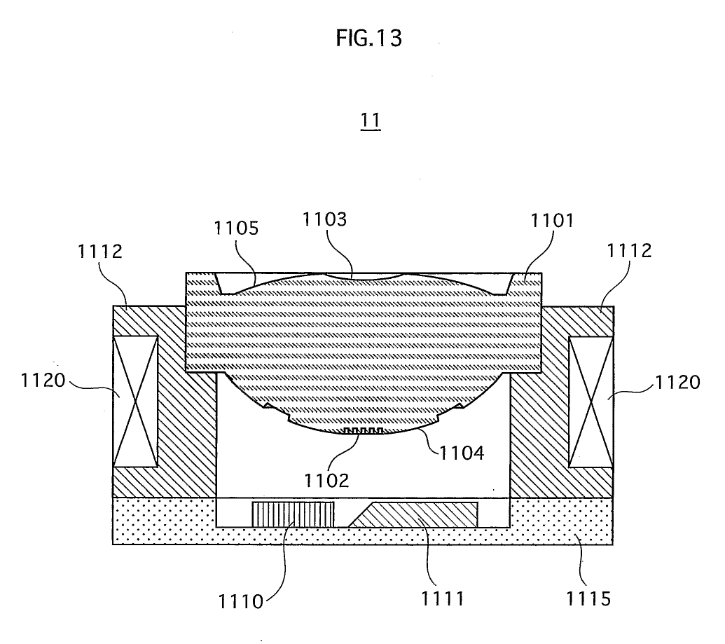

FIG. 13 is a cross-sectional view showing the structure of the optical head pertaining to the present embodiment. Optical head 11 is provided with a housing 1112, a magnet 1120, a cap 1115, a light-emitting element 1110, a focusing element 1101, and a light-receiving element 1111, as shown in FIG. 13.

A thru hole, circular in plan view, is provided in a central portion of housing 1112, and focusing element 1101 is fitted into the opening at one end of the housing. The present embodiment differs from embodiment 1 in that the opening at the other end is only covered with cap 1115, without a support plate being fitted therein.

A concave portion, whose base is the same diameter as the thru hole, is formed in the focusing element side of cap 1115. Light-emitting element 1110 and light-receiving element 1111 are disposed in this concave portion.

A lens surface 1105 and a mirror surface 1103 are formed on the surface of focusing element 1101 to face the optical disc, similarly to embodiment 1. Mirror surface 1103 is a convex mirror. A diffraction grating 1102 and a mirror surface 1104 are formed on the light-emitting element side of focusing element 1101. Mirror surface 1104 reflects laser light incident from inside of focusing element 1101.

Mirror surface 1104 is a generally concave mirror that focuses laser light reflected by mirror surface 1103 onto the recording surface of the optical disc. An annular groove centered on the optical axis of focusing element 1101 is provided in mirror surface 1104. This groove divides mirror surface 1104 into mirror surfaces 1104a, 1104b and 1104c. Mirror surface 1104a, which is the portion sandwiched between diffraction grating 1102 and the groove, is an aspheric concave mirror. Mirror surface 1104b is the groove in mirror surface 1104, the base of which is an aspheric concave mirror. Mirror surface 1104c is an annular aspheric mirror surface that surrounds mirror surface 1104b.

Mirror surfaces 1104a and 1104c are concave mirrors expressed by the same aspheric function. The boundary between the mirror surfaces is determined so that the angle of incidence of laser light incident on mirror surface 1104 is constant. The height D of the groove constituting mirror surface 1104b is expressed by the equation

$$D = \frac{λ}{4 {η}_{1}}$$

Here, λ is the wavelength of laser light emitted by light-emitting element 1110, and n₁ is the refractive index of the material that constitutes focusing lens 1101. Setting the groove to this depth enables the phase difference between laser light reflected by mirror surfaces 1104b and laser light reflected by mirror surfaces 1104a and 1104c to be set to 180 degrees.

### 4-2. Optical Characteristics

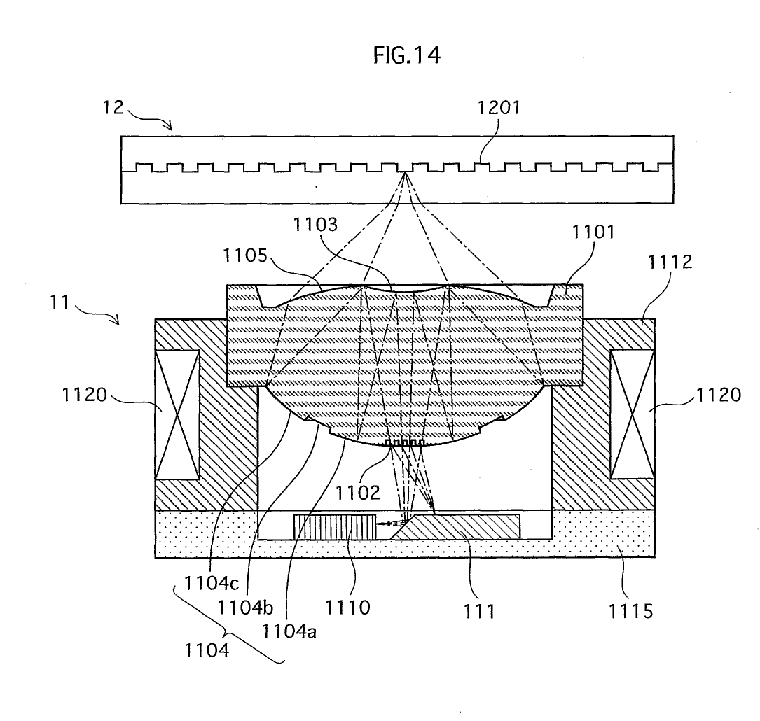

FIG. 14 is a cross-sectional view showing the optical characteristics of optical head 11. After being reflected through diffraction grating 1102 by the mirror surface formed on the end surface of the light-receiving element, laser light emitted by light-emitting element 1110 is reflected by mirror surface 1103 onto mirror surface 1104, and the reflected light of mirror surface 1104 is then focused onto a recording surface 1201 of an optical disc 12 after being refracted by lens surface 1105, to form a beam spot on the recording surface, as shown in FIG. 11.

Since the side lobes of the beam spot are reduced, the light intensity of reflected light accurately reflects the recorded state of recording surface 1201, as noted above. Light reflected by recording surface 1201 is refracted onto mirror surface 1104 by lens surface 1105, and the reflected light of mirror surface 1104 is then diffracted by diffraction grating 1102 after being reflected by mirror surface 1103. First-order diffracted light incident on light-receiving element 1111 is photoelectrically converted into electrical signals.

### 4-3. Variations of Present Embodiment

The present embodiment is described in terms of a groove being provided in mirror surface 1104 as a mirror surface 1104b. Needless to say, the present invention is not limited to this, and may alternatively be constituted as follows. That is, a flat annular convex portion may be provided on mirror surface 1104 as a mirror surface. Similar effects to the above can be obtained by making the height of the convex portion the same as the depth of the groove.

### 5. Variations

Needless to say, the present invention described above based on the preferred embodiments is not limited to these embodiments. The following variations can also be implemented.

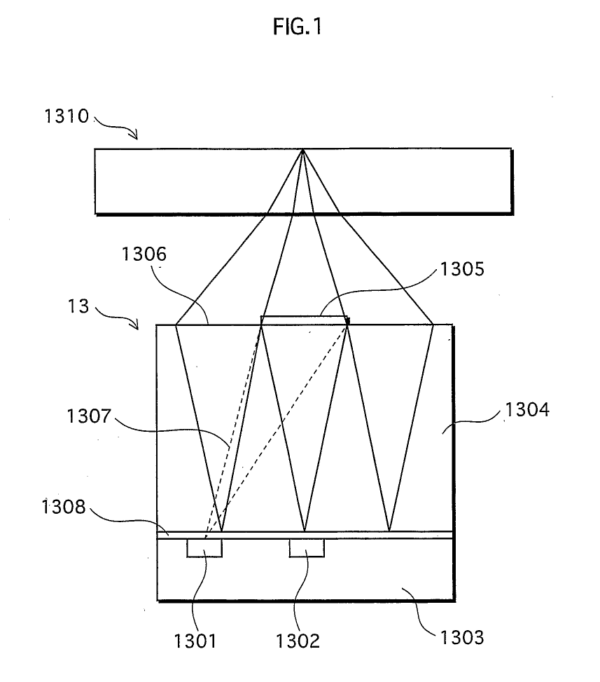

(1) The effects of the present invention can be obtained even with the prior art structure shown in FIG. 1, by making mirror surface 1308 similar in shape to mirror surface 107 pertaining to embodiment 1 or mirror surface 502 pertaining to embodiment 2.

(2) Although not particularly mentioned in the preferred embodiments, the effects of the present invention can be obtained through any combination of the embodiments and variations.

(3) The housing and the cap are separate components in the preferred embodiments. Needless to say, the present invention is not limited to this, and the housing and cap may be formed as one piece. This enables the cost of the optical head to be reduced by decreasing the number of components.

### INDUSTRIAL APPLICABILITY

An optical head pertaining to the present invention is useful as a device that accurately reads information recorded on an optical disc at a high recording density.

1. An optical head operable to read from and/or record to an optical recording medium, comprising:
a light-emitting element operable to emit a beam;
a first reflective mirror adapted to reflect the beam toward the light-emitting element; and
a second reflective mirror adapted to reflect the beam reflected by the first reflective mirror, toward the optical recording medium, wherein
the first reflective mirror blocks a principal ray of the beam traveling toward the optical recording medium from the second reflective mirror,
the second reflective mirror consists of a plurality of concentric annular mirrors centered on the principal ray of the beam, and
the concentric annular mirrors are separated from each other by a predetermined interval.

2. An optical head operable to read from and/or record to an optical recording medium, comprising:
a light-emitting element operable to emit a beam;
a first reflective mirror adapted to reflect the beam toward the light-emitting element;
a second reflective mirror adapted to reflect the beam reflected by the first reflective mirror, toward the optical recording medium; and
a phase adjusting unit adapted to adjust a phase of the beam incident on the optical recording medium at a predetermined angle, wherein
the first reflective mirror blocks a principal ray of the beam traveling toward the optical recording medium from the second reflective mirror, and
the phase adjusting unit is disposed on an optical path from the first reflective mirror to the optical recording medium.

3. The optical head of claim 2, wherein the phase adjusting unit is one of a concave portion and a convex portion provided in the second reflective mirror.

4. The optical head of claim 3, wherein a height D of the concave or convex portion is expressed by an equation
$$D = \frac{λ}{4 n}$$
where λ is a wavelength of the beam emitted by the light-emitting element, and n is a refractive index of a substance that the beam passes through when incident on the second reflective mirror.

5. The optical head of claim 4, wherein the refractive index n of the substance that the beam passes through when incident on the second reflective mirror is approximately equal to 1, and the height D of the concave or convex portion is expressed by an equation
$$D = \frac{λ}{4}$$

6. The optical head of claim 2, further comprising:
a lens surface disposed on an optical path from the light-emitting element to the optical recording medium, and adapted to refract the beam, wherein
the phase adjusting element is one of a concave portion and a convex portion provided in the lens surface.

7. The optical head of claim 6, wherein a height D of the concave or convex portion is expressed by an equation
$$D = \frac{λ}{2 ( {n}_{1} - {n}_{0} )}$$
where λ is a wavelength of the beam emitted by the light-emitting element, n₀ is a refractive index of a substance that the beam passes through before being incident on the lens surface, and n₁ is a refractive index of a substance that the beam passes through after being incident on the lens surface.

8. An optical head operable to read from and/or record to an optical recording medium, comprising:
a light-emitting element operable to emit a beam;
a focusing element being a convex lens whose optical axis substantially coincides with a principal ray of the beam, and in which a central portion of a surface facing the light-emitting element is a transmission diffraction grating, and a central portion of a surface to face the optical recording medium is a first reflective mirror adapted to reflect the beam toward the light-emitting element;
a second reflective mirror adapted to reflect the beam reflected by the first reflective mirror via the transmission diffraction grating, toward the focusing element;
a light-receiving element adapted to receive first-order diffracted light diffracted by the transmission diffraction grating, out of the reflected beam from the optical recording medium, wherein
the second reflective mirror consists of a plurality of concentric annular plane mirrors,
the plane mirrors are separated from each other, and
the reflective index between the plane mirrors is lower than the reflective index of the plane mirrors.

9. An optical head operable to read from and/or record to an optical recording medium, comprising:
a light-emitting element operable to emit a beam;
a focusing element being a convex lens whose optical axis substantially coincides with a principal ray of the beam, and in which a central portion of a surface facing the light-emitting element is a transmission diffraction grating, and a central portion of a surface to face the optical recording medium is a first reflective mirror adapted to reflect the beam toward the light-emitting element;
a second reflective mirror adapted to reflect the beam reflected by the first reflective mirror via the transmission diffraction grating, toward the focusing element; and
a light-receiving element adapted to receive first-order diffracted light diffracted by the transmission diffraction grating, out of the reflected beam from the optical recording medium, wherein
an annular portion of the second reflective mirror centered on the optical axis of the convex lens is one of elevated and depressed in an optical axis direction in comparison to other portions of the second reflective mirror.

10. An optical head operable to read from and/or record to an optical recording medium, comprising:
a light-emitting element operable to emit a beam;
a focusing element being a convex lens whose optical axis substantially coincides with a principal ray of the beam, and in which a central portion of a surface facing the light-emitting element is a transmission diffraction grating, and a central portion of a surface to face the optical recording medium is a first reflective mirror adapted to reflect the beam toward the light-emitting element;
a second reflective mirror adapted to reflect the beam reflected by the first reflective mirror via the transmission diffraction grating, toward the focusing element; and
a light-receiving element adapted to receive first-order diffracted light diffracted by the transmission diffraction grating, out of the reflected beam from the optical recording medium, wherein
an annular portion of a lens surface of the focusing element centered on the optical axis of the convex lens is expressed by a different lens function to other portions of the lens surface.

11. An optical head operable to read from and/or record to an optical recording medium, comprising:
a light-emitting element operable to emit a beam;
a focusing element being a convex lens whose optical axis substantially coincides with a principal ray of the beam, and in which a central portion of a surface facing the light-emitting element is a transmission diffraction grating, a portion of the surface facing the light-emitting element excluding the transmission diffraction grating is a concave mirror, and a central portion of a surface to face the optical recording medium is a first reflective mirror adapted to reflect the beam toward the light-emitting element; and
a light-receiving element adapted to receive first-order diffracted light diffracted by the transmission diffraction grating, out of the reflected beam from the optical recording medium, wherein
an annular portion of the concave mirror centered on the optical axis of the convex lens is one of elevated and depressed in comparison to other portions of the concave mirror.
